(19) United States
(12) Patent Application Publication
(10) Pub. No.: US 2016/0285937 A1
(43) Pub. Date: Sep. 29, 2016

(54) PLAYBACK OF STREAMED MEDIA CONTENT

(71) Applicant: SPOTIFY AB, Stockholm (SE)

(72) Inventors: Brian Whitman, Brooklyn, NY (US); Matthew S. Ogle, New York, NY (US); David P. Rodger, Arlington, MA (US)

(21) Appl. No.: 15/078,044

(22) Filed: Mar. 23, 2016

Related U.S. Application Data
(60) Provisional application No. 62/137,489, filed on Mar. 24, 2015.

(51) Int. Cl. H04L 29/06; G06F 3/0482; G06F 17/30; G06F 3/16

(52) U.S. Cl. CPC H04L 65/4084; G06F 3/165; G06F 3/0482; G06F 17/30772

(57) ABSTRACT

The present disclosure generally relates to the providing of media content, e.g. audio content in the form of music. More particularly, the present disclosure relates to systems, methods, computer server systems and electronic devices for playback of streamed media content. A visual array of one or several media options that correspond to one or more proposed media playlists can be provided at the user interface of the electronic devices. This makes it possible to facilitate the browsing, and thus the selection, of media content. The one or more proposed media playlists are based on previously played media and, accordingly, the proposed media playlists become personalized to fit the taste of the user of the electronic device.

### CROSS-REFERENCE TO RELATED APPLICATION

This application claims priority to U.S. Provisional Application No. 62/137,489 filed Mar. 24, 2015, the contents of which are incorporated herein by reference.

### BACKGROUND OF THE INVENTION

1. Technical Field

The present disclosure generally relates to the providing of media content, e.g. audio content in the form of music or, alternatively, video content. More particularly, the present disclosure relates to systems, methods, computer server systems and electronic devices for playback of streamed media content.

2. Background

As computer technology has improved, the digital media industry has evolved greatly in recent years. Users are able to use electronic devices (e.g., smart phones, tablet computers, laptop computers, media devices, etc.) to consume music, video and other forms of media content. For instance, users can listen to audio content (e.g., music) or watch video content on a variety of electronic devices.

At the same time, advances in network technology have increased the speed and reliability at which information can be transmitted over computer networks. It is therefore possible for users to stream media content over computer networks as needed, or on demand, rather than transmitting a complete file in physical media (such as CD or DVD, or downloading the entire file) before consuming the media content.

When consuming media, the locating of a particular media option from a media collection (e.g., locating a movie from a movie collection or locating a certain playlist of songs from a collection of music albums) may be difficult. For example, it may be difficult to browse a multitude of available media options to some users. The browsing of media content may therefore become unnecessarily time consuming and, hence, cumbersome to some users. In turn, this may be frustrating to some users, particularly at times when the user cannot devote all of his or her attention to making the selection.

### SUMMARY

It is in view of the above considerations and others that the various embodiments disclosed herein have been made.

There is a need for a solution that allows for an improved user experience when consuming media, e.g. in the form of streamed media. Advantageously, such a solution would also enable a more personalized user experience when consuming media. Also, it would be advantageous if such a solution requires less user interaction.

Accordingly, it is a general object of the embodiments of the present technology to allow for an improved user experience when consuming media content.

In a first aspect, the technology disclosed herein concerns a system for playback of streamed media content. The system comprises an electronic device including a first processing circuit, a first communication circuit, a first memory, and a user interface. Also, the system comprises a computer server system including a second processing circuit, a second communication circuit, and a second memory storing at least one data message that is to be operated on. Each one of the at least one data message includes (a) a subscriber identity parameter associated with said electronic device, and (b) information related to previously played media content associated with the subscriber identity parameter.

The computer server system is configured to: retrieve the stored at least one data message from the second memory to determine (a) the subscriber identity parameter associated with said electronic device, and (b) the information related to previously played media content associated with the subscriber identity parameter; create at least one proposed media playlist based on (a) the subscriber identity parameter associated with said electronic device as well as the (b) information related to previously played media associated with the subscriber identity parameter; generate a media data message including said at least one proposed media playlist; and communicate a signal including said media data message to the electronic device.

The electronic device is configured to: receive said media data message including said at least one proposed media playlist; in response thereto generate a visual array of at least one media option corresponding to said at least one proposed media playlist; and provide said visual array of the at least one media option at the user interface.

In one embodiment, the electronic device is further configured to arrange the at least one media option in a two-dimensional grid or list and to provide the at least one media option in said two-dimensional grid or list.

In one embodiment, the electronic device is further configured to provide each one of the at least one media option in the form of a card, the card including metadata related to the media option.

The media content may be audio content. The audio content may, for example, be music or, alternatively, a podcast or the like.

Alternatively, the media content may be video content.

In a second aspect, the technology disclosed herein concerns a method of assisting in the generation of visual media playlists at a user interface of an electronic device. The method is performed by a computer server system (e.g., comprising one or several computer servers) including a processing circuit, a communication circuit, and a memory storing at least one data message that is to be operated on. Each of the at least one data message includes (a) a subscriber identity parameter associated with said electronic device, and (b) information related to previously played media content associated with the subscriber identity parameter.

The method comprises: retrieving, by the processing circuit, the stored at least one data message from the memory to determine (a) the subscriber identity parameter associated with said electronic device, and (b) the information related to previously played media content associated with the subscriber identity parameter; creating, by the processing circuit, at least one proposed media playlist based on (a) the subscriber identity parameter associated with said electronic device as well as the (b) information related to previously played media content associated with the subscriber identity parameter; generating, by the processing circuit, a media data message including said at least one proposed media playlist; and communicating, by the communication circuit, a signal including said media data message to the electronic device.

In one embodiment, the method comprises collecting, by the processing circuit, the information related to previously played media content associated with the subscriber identity parameter during a predefined period of time; and storing, in the memory, said information related to previously played media content associated with the subscriber identity parameter.

The predefined period of time may be a prior day or a portion thereof.

The predefined period of time may be a corresponding period of time of a prior day.

The predefined period of time may include the last 24 hours.

In one embodiment, the method further comprises: receiving, by the communication circuit, a signal from the electronic device, the signal comprising a data message including information about a current position of the electronic device; and wherein creating, by the processing circuit, said at least one proposed media playlist is further based on the current position of the electronic device.

In one embodiment, the method comprises: establishing, by the processing circuit, the time of a day; and wherein creating, by the processing circuit, said at least one proposed media playlist is further based on the established time of the day. In one embodiment, the establishing the time of a day comprises: receiving, by the communication circuit, a signal from the electronic device, the signal comprising a data message including information about a time zone location of the electronic device; and wherein establishing, by the processing circuit, the time of a day comprises utilizing the information about the time zone location.

The media content may be audio content. The audio content may e.g. be music or, alternatively, a podcast or the like.

Alternatively, the media content may be video content.

In a third aspect, the technology disclosed herein concerns a computer server system. In one embodiment, the computer server system comprises means adapted to perform the method of the second aspect. In one example implementation, the computer server system comprises one or several processing units adapted to perform the method of the second aspect. In another example implementation, the computer server system comprises one or more processors and memory storing one or more programs for execution by the one or more processors, wherein the one or more programs include instructions for performing the method of the second aspect.

As will be appreciated, the computer server system may comprise one single computer server or, alternatively, a plurality of computer servers.

In a fourth aspect, the technology disclosed herein concerns a computer readable storage medium storing one or more programs, the one or more programs comprising instructions, which, when executed by a computer server system with one or more processors, cause the computer server system to perform the method of the second aspect.

In a fifth aspect, the technology disclosed herein concerns a method performed by an electronic device for generating visual media playlists at a user interface of the electronic device. The electronic device includes a processing circuit, a communication circuit, and memory.

The method comprises: receiving, by the communication circuit, a media data message including at least one proposed media playlist, wherein the at least proposed media playlist is based on (a) a subscriber identity parameter associated with the electronic device and the (b) information related to previously played media associated with the subscriber identity parameter; in response thereto generating, by the processing circuit, a visual array of at least one media option corresponding to said at least one proposed media playlist; and providing, by the processing circuit, said visual array of the at least one media option at the user interface of the electronic device.

In one embodiment, the method comprises generating the visual array of the at least one media option comprises arranging the at least one media option in a two-dimensional grid or list; and providing said visual array of the at least one media option at the user interface comprises providing the at least one media option in said two-dimensional grid or list. In one embodiment, the method comprises providing each one of the at least one media option in the form of a card, the card including metadata related to the media option.

The media content may be audio content. The audio content may e.g. be music or, alternatively, a podcast or the like.

Alternatively, the media content may be video content.

In a sixth aspect, the technology disclosed herein concerns an electronic device. In one embodiment, the electronic devices comprise means adapted to perform the method of the fifth aspect. In one example implementation, the electronic device comprises a processing unit adapted to perform the method of the fifth aspect. In another example implementation, the electronic device comprises one or more processors; and memory storing one or more programs for execution by the one or more processors, the one or more programs including instructions for performing the method of the fifth aspect.

The electronic device may be a stationary electronic device, such as a stationary computer.

Alternatively, the electronic device according may be a portable electronic device, such as a mobile telephone, a cellular telephone, a tablet computer, a laptop computer, or a personal digital assistant.

In a seventh aspect, the technology disclosed herein concerns a computer readable storage medium storing one or more programs, the one or more programs comprising instructions, which, when executed by an electronic device with one or more processors, cause the electronic device to perform the method of the fifth aspect.

### BRIEF DESCRIPTION OF DRAWINGS

These and other aspects, features and advantages will be apparent and elucidated from the following description of various embodiments, reference being made to the accompanying drawings, in which:

FIG. 1 illustrates a system for playback of video content, in accordance with an embodiment;

FIG. 2 illustrates an example embodiment of a user interface which supports playback of audio content;

FIG. 3A illustrates another example embodiment of a user interface which supports playback of audio content;

FIG. 3B is the same example embodiment as FIG. 3A with reference signs included;

FIGS. 4A-4E illustrate flowcharts of a method according to various embodiments;

FIGS. 5A-5C illustrate flowcharts of a method according to various embodiments;

FIG. 6 illustrates a carrier containing a computer program, in accordance with an embodiment;

FIGS. 7A-7D schematically illustrate a first use case scenario where embodiments of this disclosure may be applied; and

FIGS. 8A-8D schematically illustrate a second use case scenario where embodiments of this disclosure may be applied.

### DETAILED DESCRIPTION

The technology will now be described more fully hereinafter. The technology may, however, be embodied in many different forms and should not be construed as limited to the embodiments set forth herein; rather, these embodiments are provided by way of example so that this disclosure will be thorough and complete, and will fully convey the scope of the technology to those persons skilled in the art. Like reference numbers refer to like elements throughout the description.

As described above, some existing solutions for streaming media content may be inadequate. This disclosure recognizes that there is a need for a media streaming solution that allows for an improved user experience when consuming media content. Advantageously, such solution would enable a more personalized user experience when consuming media content. Also, it would be advantageous if such solution requires less user interaction.

Accordingly, it is a general object of the embodiments of the present technology to allow for an improved user experience when consuming media content, e.g. streamed media content.

To address this, in accordance with an embodiment, described herein is a system for playback of streamed media content. The system comprises an electronic device including a first processing circuit, a first communication circuit, a first memory, and a user interface. Also, the system comprises a computer server system including a second processing circuit, a second communication circuit, and a second memory storing at least one data message that is to be operated on. Each one of the at least one data message includes (a) a subscriber identity parameter associated with said electronic device, and (b) information related to previously played media content associated with the subscriber identity parameter. The computer server system is configured to: retrieve the stored at least one data message from the second memory to determine (a) the subscriber identity parameter associated with said electronic device, and (b) the information related to previously played media content associated with the subscriber identity parameter; create at least one proposed media playlist based on (a) the subscriber identity parameter associated with said electronic device as well as the (b) information related to previously played media associated with the subscriber identity parameter; generate a media data message including said at least one proposed media playlist; and communicate a signal including said media data message to the electronic device. The electronic device is configured to: receive said media data message including said at least one proposed media playlist; in response thereto generate a visual array of at least one media option corresponding to said at least one proposed media playlist; and provide said visual array of the at least one media option at the user interface.

The provision of a visual array of one or several media options that correspond to one or more proposed media playlists at the user interface of the electronic devices facilitate the browsing, and thus the selection, of media content. The one or more proposed media playlists are based on previously played media and, accordingly, the proposed media playlists become personalized to fit the taste of the user of the electronic device. Moreover, the one or more proposed media playlists are generated by the computer server system. The browsing of a multitude of media options can thus be facilitated in that the computer server system proposes media playlists rather than the user having to navigate through all available, and selectable, media options. This helps the user finding a media option of his or her taste more quickly.

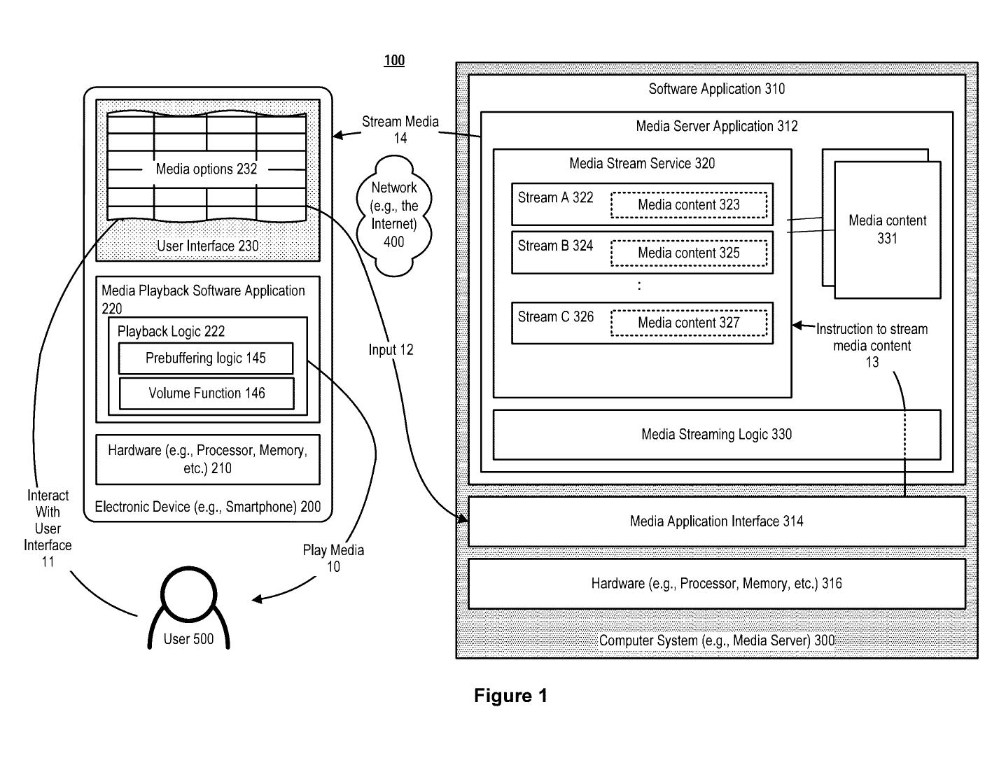

With reference to FIG. 1, an example system 100 for playback of media content will now be described in further detail. The system 100 may comprise an electronic device 200 and a computer system 300 operating as a media server. The electronic device 200 may be communicatively connectable to the computer system 300 via a network 400, such as the Internet, as is conventional and known in the existing art. As can be seen in FIG. 1, only a single electronic device 200 and a single computer system 300 are shown. However, the computer system 300 may support the simultaneous use of multiple electronic devices, and/or the electronic device 200 can simultaneously access media content at multiple computer systems.

In the following description and in order not to obscure the detailed description with unnecessary detail, the media content will generally be exemplified to be audio content in form of music. This should, however, not be interpreted as limiting the scope of the various embodiments of the disclosed technology.

As shown in FIG. 1, the electronic device 200 may be used for the playback of audio content, which is provided by the computer system 300. The electronic device 200 may be a mobile telephone, such as a smart phone. Alternatively, the electronic device 200 may be a tablet computer. In yet other embodiments, the electronic device 200 may be any other electronic device capable of playback of media content such as, for example, one of the electronic devices of the following group: a personal computer, a laptop, and a mobile electronic device (e.g. a handheld entertainment device, a digital media player, or other media device).

The electronic device 200 may include one or several physical computer resources, or hardware resources 210. The hardware resources 210 may e.g. include processing circuitry, communication circuitry and memory. Likewise, the computer system 300 operating as a media server may include one or several physical computer resources, or hardware resources 316. The hardware resources 316 may likewise include processing circuitry, communication circuitry and memory.

The computer system 300 may include an operating system or other processing system which supports execution of a software application 310, including a media server application 312 which may be used, for example, to stream media content. A media stream service 320 may be used to buffer media content, for streaming to one or more media streams 322, 324, 326. A media application interface 314 may receive requests from electronic devices 200 or other systems, to retrieve media content 331 from the computer system 300.

Media content 331, or media items, may be provided, for example, within a database or repository, or may be received by the computer system 300 from another source (not shown). This another source (not shown) could be external to the computer system 300, i.e. it may be located remotely from the computer system 300.

A media streaming logic 330 may be used to retrieve or otherwise access the media content 331 in response to requests from electronic devices 200 or other systems, and populate the media stream service with streams 322, 324, 326 of corresponding media content data 323, 325, 327 that may be returned, i.e. streamed, to the requesting electronic device 200.

The electronic device 200 comprises a user interface 230, which is adapted to display or otherwise provide a visual array of media options 232, for example as a two-dimensional grid, a list, or other visual array format, and determine a user input. Each media option in the visual array of media options 232 correspond to a respective media stream 322, 324, 326. Examples of various visual arrays 232 will be described in further detail below.

Selecting a particular media option within the visual array 232 may be used, or otherwise interpreted, as a request or instruction to the media server application 312 to stream or otherwise return a corresponding particular item of media content. For example, in accordance with some embodiments, the software application 310 at the computer system 300 may be used to stream or otherwise communicate media content to the electronic device 200, wherein the user interface 230 at the electronic device 200 is adapted to display a plurality of media options that correspond to respective media streams.

In accordance with some embodiments, the electronic device 200 may also include a media playback application 220, together with a playback logic 222, pre-buffering logic 145, and a volume function 145, which may be used to control the playback of media content that is received from the media server application 312, for playback by the electronic device 200, as described in further detail below.

A user 500 may interact 11 with the user interface 230 and issue requests, for example the playing of a selected media option on the electronic device 200. The user's selection of a particular media option (e.g., stream) may be communicated 12 to the media server application 312, via the media application interface 314. The media server application 312 may then be instructed 13 to stream corresponding media content 13, including one or more streams of media content data 323, 325, 327, and subsequently stream 14 or otherwise communicate the, e.g., selected media, to the user's electronic device 200. In accordance with some embodiments, pre-buffering requests from the electronic device 200 may also be communicated 12 to the media server application 312 via the media application interface 314. At the electronic device 200, in response to the user's interaction with the user interface 230, the media playback application 220, including the playback logic 222, may play 10 the requested media content to the user 500.

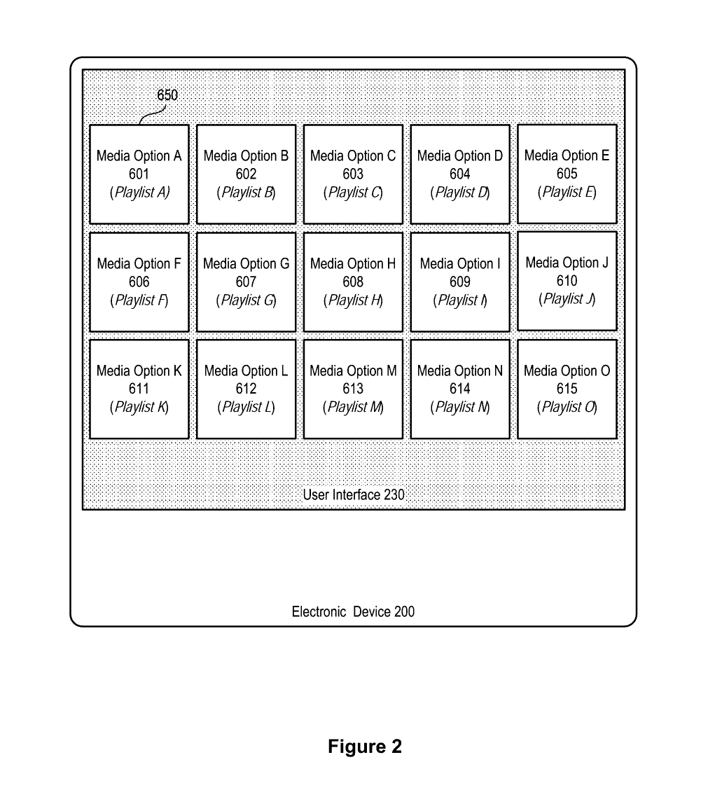

FIG. 2 illustrates an example of a visual appearance of the visual array of media options 232 displayed at the user interface 230 of the electronic device 200 of FIG. 1. As illustrated in FIG. 2, in the example shown therein, fifteen media options A (601), B (602), C (603) . . . O (615) are visualized as grid tiles 650.

In accordance with an embodiment, a plurality of media options, for example a set of song tracks, a music playlist, or the contents of an album or a media library, can be represented on the user interface as a two-dimensional visual array, wherein the plurality of media options can be provided as an array of tiles, and wherein each tile can be associated with a particular visualization, for example a cover art identifying a represented music play list. In accordance with other embodiments, other forms of visualization can be used for the media options, for example texts, colors, images, or animations. While a selected point or region is moved within the grid of media options, the visualization or appearance of those media options that are proximate to the selected point or region may for example be modified, for example by varying their opacity, to reflect their status as proximate media options. For example, in accordance with an embodiment, the opacity of a particular point or region, including the closest media option and/or proximate media options, can be modified to render the closest or proximate media options to a selected point or region in a more visible manner than other (not selected, or not proximate) options.

In accordance with an embodiment, a user can provide input as a user selection of a point or region within a selectable media option. In accordance with an embodiment, the user interface can be a touch-sensitive user interface, which recognizes input in the form of touch, for example the position of a user's finger or a stylus upon the user interface, to determine the selected point or region within the visual array of media options. Similarly, the user interface can determine the selected point or region as it is being moved, in response to a user input, within the visual array of media options. In the case of a mouse-based interface, the input can be provided by a mouse-down event. In accordance with an embodiment, the system can, upon receiving the user input, initialize playback of those media options associated with the selected point or region.

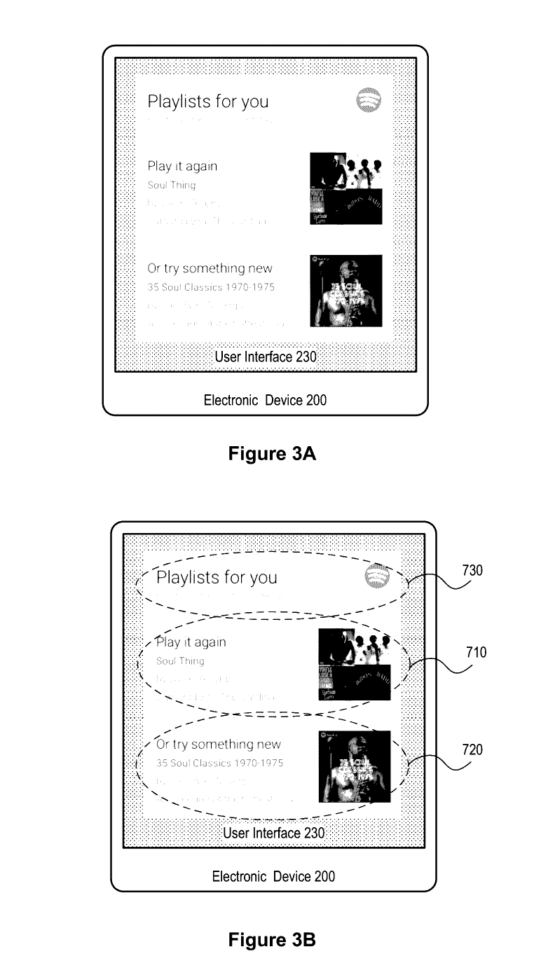

FIGS. 3A and 3B illustrate another example of a visual appearance of the visual array of media options 232 displayed at the user interface 230 of the electronic device 200 of FIG. 1. In this example, each one of the media options is provided in the form of a card 710, 720 (or grid tile). Each displayed card (or, grid tile) 710, 720, 730 may include metadata related thereto.

For example, in the illustrated example, a first card 730 may include metadata <Playlists for you>. This first card 730 may, hence, be a card for the sole purpose of presenting the other cards 710, 720, i.e. the media content associated with these cards 710, 720. In other words, card 730 does not necessarily correspond to an available, thus selectable, media option. As can be seen in FIG. 3A, the first card 730 may comprise additional metadata, such as <Based on your recent Spotify listening>, to further explain the media content to a user when displayed at the user interface 230.

The second card 710 may include metadata <Play it again> and optionally additional metadata such as <Frequently-played playlist title>, <Owner of frequently-played playlist title>, <Number of songs>, <Artist preview>, and <Playlist description>. According to an example embodiment, the second card 710 may be based on a user's previously played media content, e.g. the mostly played song tracks or the mostly played music playlists, as will be further detailed hereinbelow.

The third card 720 may include metadata <Or try something new and awesome> and optionally additional metadata such as <Recommended playlist title>, <Owner of playlist>, <Number of songs>, <Artist preview>, <Playlist description>. According to an example embodiment, the third card 720 may also be based on a user's previously played media content, e.g. the mostly played song tracks or the mostly played music playlists, as will be further detailed herein below.

### Example Methods

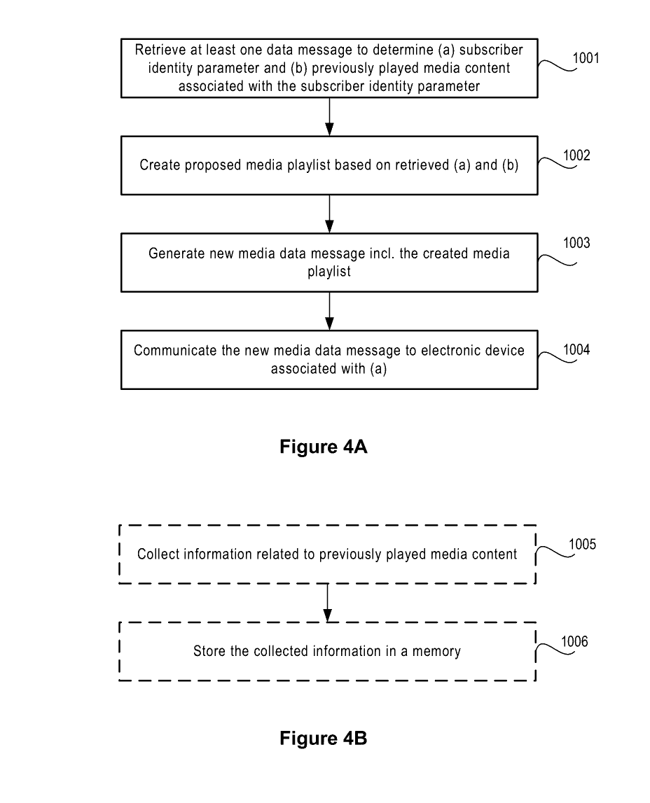

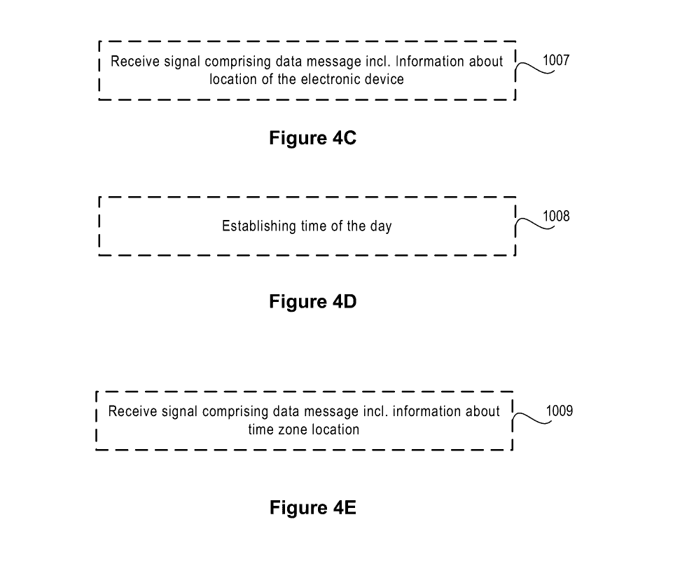

FIG. 4 illustrates an example method of assisting in the generation of visual media playlists at a user interface 230 of an electronic device 200. The method is performed by a computer server system 300 (see FIG. 1). Typically, the computer server system 300 comprises hardware resources 316. The hardware resources may e.g. include a processing circuit or processor, and a communication circuit or communication interface. The communication circuit may be provided in order to allow the computer server system to communicate with electronic devices 200 and/or one or more other computer server systems 300, e.g. via a network 400 such as the Internet (see FIG. 1). To this end, the communications circuit may comprise a transmitter (Tx) circuit and a receiver (Rx) circuit. Alternatively, the communication circuit may comprise a transceiver circuitry combining both transmission and reception capabilities. The communications circuit may include a radio frequency (RF) circuit, or RF interface, allowing the computer server system to communicate with electronic devices 200 and/or servers 300 through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth®, etcetera. Furthermore, the computer server system 300 comprises one or more memories storing at least one data message that is to be operated on. Each one of the at least one data message includes (a) a subscriber identity parameter associated with said electronic device, and (b) information related to previously played media content associated with the subscriber identity parameter.

The method may comprise the step, or action, of retrieving 1001 or otherwise accessing, by the processing circuit, the stored at least one data message from the memory to determine (a) the subscriber identity parameter associated with said electronic device, and (b) the information related to previously played media content associated with the subscriber identity parameter.

The method may further comprise the step, or action, of creating 1002 or otherwise generating, by the processing circuit, at least one proposed media playlist based on (a) the subscriber identity parameter associated with said electronic device as well as the (b) information related to previously played media content associated with the subscriber identity parameter.

The method may further comprise the step, or action, of generating 1003, by the processing circuit, a media data message including said at least one proposed media playlist.

The method may further comprise communicating (e.g. transmitting), by the communication circuit, a signal including said media data message to the electronic device 200, which is associated with the retrieved subscriber identity parameter.

In some embodiments, as schematically illustrated in FIG. 4B, the method may comprise the additional and optional steps, or actions, of collecting 1005, by the processing circuit, the information related to previously played media content associated with the subscriber identity parameter during a predefined period of time; and storing 1006, in the memory, said information related to previously played media content associated with the subscriber identity parameter.

For example, the predefined period of time may be a prior day or a portion thereof. Preferably, but not necessarily, the predefined period of time may be corresponding period of time of a prior day. Additionally, or alternatively, the predefined period of time may include the last 24 hours.

In some embodiments, as schematically illustrated in FIG. 4C, the method may additionally comprise the optional steps, or actions, of receiving 1007, by the communication circuit, a signal from the electronic device, the signal comprising a data message including information about a current position of the electronic device. If so, the step or action of creating 1002 (see FIG. 4A), by the processing circuit, said at least one proposed media playlist may additionally, or alternatively, be based on the current position of the electronic device. This may allow for a location-aware creation 1002 of the proposed media playlist.

In some embodiments, as schematically illustrated in FIG. 4D, the method may additionally comprise establishing 1008 or otherwise determining, by the processing circuit, the time of a day. For example, the time of the day can be established in the following format yyyy.mm.dd, hh:mm (i.e. year, month, date, hour:minutes). If so, the step or action of creating 1002 (see FIG. 4A), by the processing circuit, said at least one proposed media playlist may additionally, or alternatively, be based on the established time of the day. This may allow for a time-aware creation 1002 of the proposed media playlist. In some advantageous embodiments, as schematically illustrated in FIG. 4E, the step 1008 or action of establishing the time of a day further comprises: receiving 1009, by the communication circuit, a signal from the electronic device 200, the signal comprising a data message including information about a time zone location of the electronic device 200. If so, the step or action of establishing 1008, the time of a day may additionally comprise utilizing the information about the time zone location.

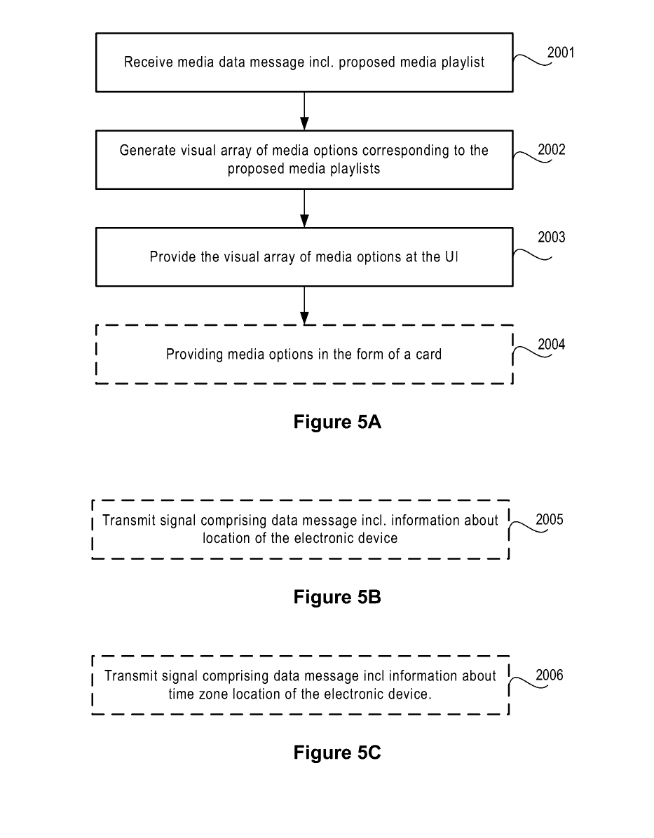

FIG. 5A illustrates an example method performed by an electronic device 200 for generating visual media playlists at a user interface 230 of the electronic device 200. The electronic device may be a stationary electronic device, such as a stationary computer. Alternatively, the electronic device 200 may be embodied as a portable electronic device, such as a mobile telephone, a cellular telephone, a tablet computer, a laptop computer, or a personal digital assistant.

Typically, the electronic device 200 comprises hardware resources 210 (see FIG. 1). The hardware resources 210 may, for example, include a processing circuit or processor, and a communication circuit or communication interface. The communication circuit may be provided in order to allow the computer server system to communicate with other electronic devices 200 and/or one or more other computer server systems 300, e.g. via a network 400. To this end, the communications circuit may comprise a Tx circuit and a Rx circuit. Alternatively, the communication circuit may comprise a Tx/Rx circuit combining both transmission and reception capabilities. The communications circuit may include a radio frequency (RF) circuit, or RF interface, allowing the electronic device 200 to communicate with other electronic devices 200 and/or servers 300 through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth®, etcetera.

Moreover, the electronic device 200 may further comprise a user interface (UI) 230, which may be comprised of a display and a keypad. Advantageously, the UI 230 is a touch-sensitive UI. As such, a display of the touch-sensitive UI may be a touch screen display upon which virtual keys may be displayed and operated.

With continued reference to FIG. 5A, the method may comprise receiving 2001, by the communication circuit, a media data message including at least one proposed media playlist, wherein the at least proposed media playlist is based on (a) a subscriber identity parameter associated with the electronic device and the (b) information related to previously played media associated with the subscriber identity parameter.

In response thereto, the method may further comprise generating 2002 or otherwise creating, by the processing circuit, a visual array 232 of at least one media option corresponding to said at least one proposed media playlist.

Also, the method may further comprise providing 2003, by the processing circuit, said visual array 232 of the at least one media option at the UI 230 of the electronic device 200.

Advantageously, generating 2002 the visual array of the at least one media option may comprise arranging the at least one media option in a two-dimensional grid or list. Furthermore, providing 2003 said visual array of the at least one media option at the user interface may advantageously comprise providing the at least one media option in said two-dimensional grid or list. In some embodiments, as schematically illustrated in FIGS. 3A-3B, each one of the at least one media option may be provided 2004 in the form of a card (or grid tile). As described earlier with reference to FIG. 3, the card may include metadata related to the media option in question.

With continued reference to FIG. 3, it will be appreciated that a user operating the electronic device 200 may be presented one or several media options in the form of cards 710, 720, 730. Some of the cards 710, 720 correspond to proposed playlist that are generated, or otherwise, created by the computer server system 300. In the example implementation shown in FIG. 3, a first card 710 corresponds to a playlist that is merely a previously played media play list, e.g. a number of previously played songs. Also, a second card 720 corresponds to a playlist that is an automatically generated playlist, whose songs are based on previously played media and/or affinity with previously played media.

For example, embodiments of the technology presented herein may utilize the established time of the day for e.g. the following purposes: 1) when looking at the previous day's history to select a previously-played playlist to surface at the UI 230 of the electronic device 200, and/or 2) when scheduling the card 710, 720 for display at the UI 230 (e.g., it is possible to schedule the cards 710, 720 to be shown automatically at a similar time as a playback session of a prior day).

In order to create, or otherwise, generate the proposed media playlist, the computer server system 300 may be capable of analyzing the musical content of a previously played playlist, and e.g. use collaborative filtering and/or vectors to find a proposed playlist that has a high musical content affinity with the earlier-played playlist. In one example implementation, the established time of day and/or location of the electronic device is utilized as a final check only, e.g. in order to filter out obviously inappropriate recommendations (e.g., not recommending “Morning Commute Jams” to the user at 8 pm in the evening).

Referring to FIGS. 5B and 5C, in some embodiments, the method discussed above in connection with FIG. 5A may additionally comprise the optional steps, or actions, of transmitting 2005, by the communication circuit, a signal to the computer server system 300, the signal comprising a data message including information about a current position of the electronic device 200. Additionally, or alternatively, the method may comprise transmitting 2006, by the communication circuit, a signal from the electronic device 200, the signal comprising a data message including information about a time zone location of the electronic device 200.

### Example Computer-Readable Mediums

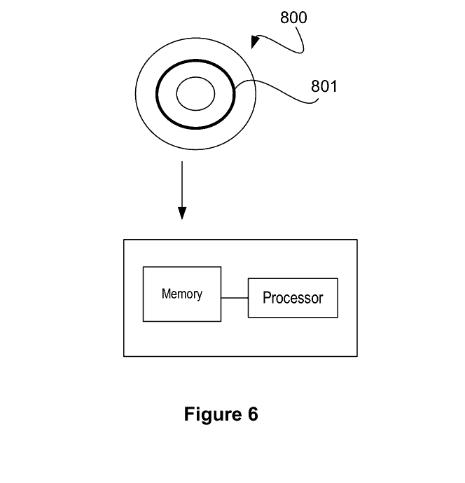

Turning now to FIG. 6, another embodiment will be briefly discussed. FIG. 6 shows an example of a computer-readable medium, in this example in the form of a data disc 800. In one embodiment the data disc 800 is a magnetic data storage disc. The data disc 800 is configured to carry instructions 801 that can be loaded into a memory of an apparatus. Upon execution of said instructions by a processor of the apparatus, the apparatus is caused to execute a method or procedure according to the any one of the embodiments disclosed in this disclosure. The data disc 800 is arranged to be connected to or within and read by a reading device (not shown), for loading the instructions into the processor. One such example of a reading device in combination with one (or several) data disc(s) 800 is a hard drive. It should be noted that the computer-readable medium can also be other mediums such as compact discs, digital video discs, flash memories or other memory technologies commonly used. In such an embodiment the data disc 800 is one type of a tangible computer-readable medium. The instructions may alternatively be downloaded to a computer data reading device, such as a computer or other electronic device capable of reading computer coded data on a computer-readable medium, by comprising the instructions in a computer-readable signal (not shown) which is transmitted via a wireless (or wired) interface (for example via the Internet) to the computer data reading device for loading the instructions into a processor of the apparatus. In such an embodiment, the computer-readable signal is one type of a non-tangible computer-readable medium.

Various embodiments described herein allow for the provision of a visual array of one or several media options that correspond to one or more proposed media playlists at a user interface of an electronic device. The provision of this visual array of one or several media options may allow for facilitating the browsing, and thus the selection, of media content. The one or more proposed media playlists are based on previously played media and, accordingly, the proposed media playlists become personalized to fit the taste of the user of the electronic device. Moreover, the one or more proposed media playlists may generated automatically by the computer server system, i.e. without the user instructing the computer server system to compile the proposed media playlists. The browsing of a multitude of media options can thus be facilitated in that the computer server system proposes media playlists rather than the user having to navigate through all available, and selectable, media options. This helps the user finding a media option of his or her taste more quickly.

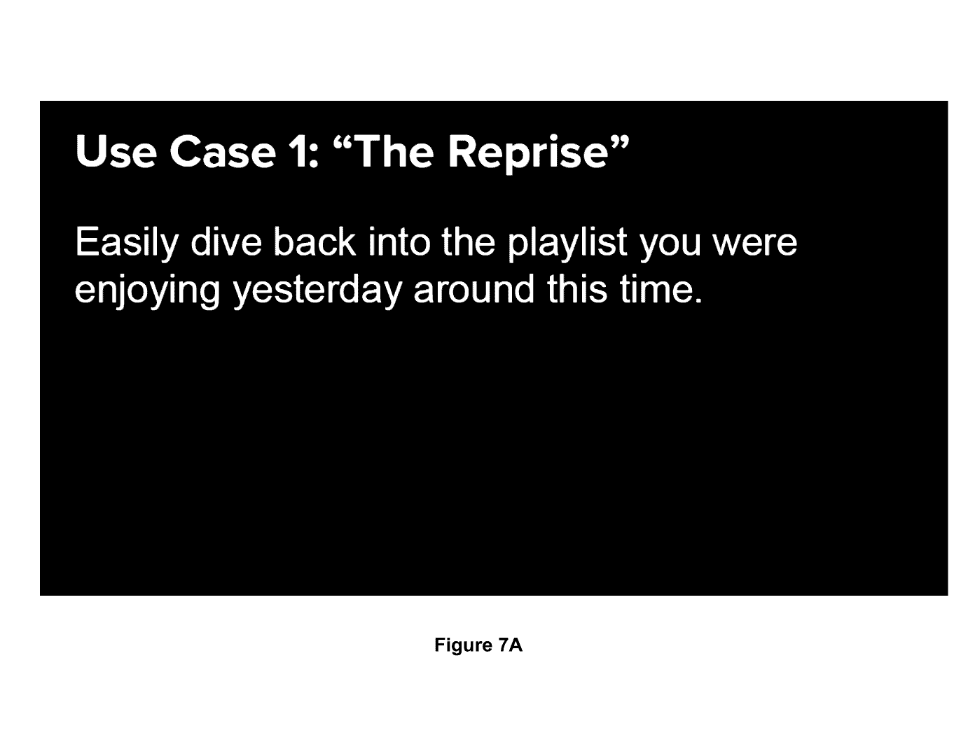

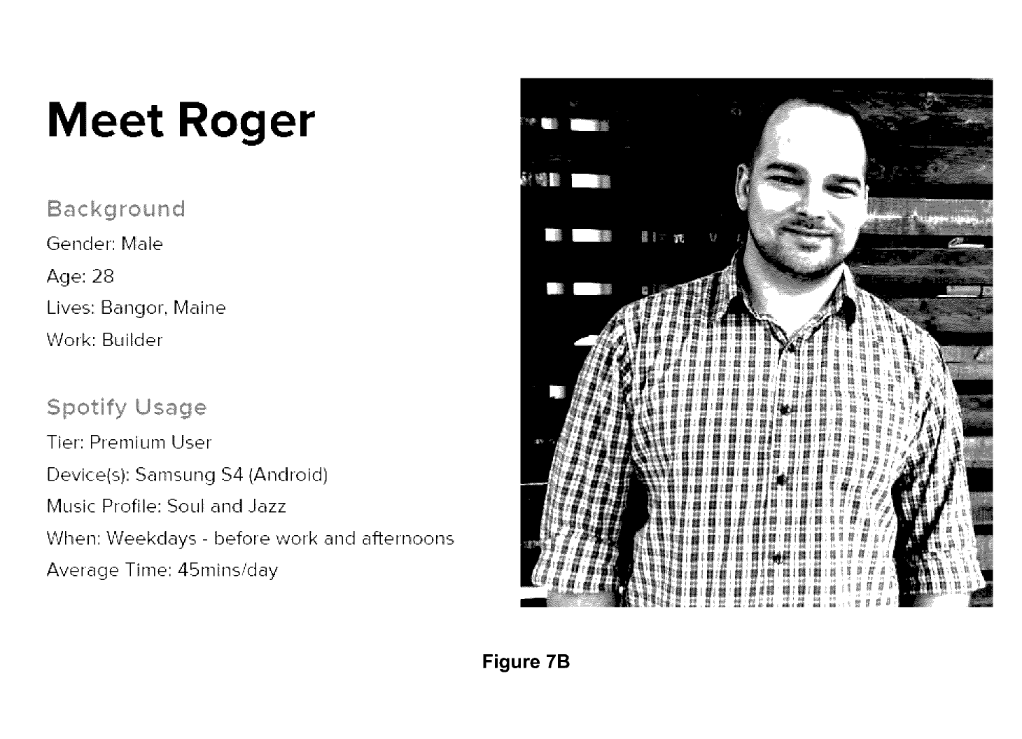

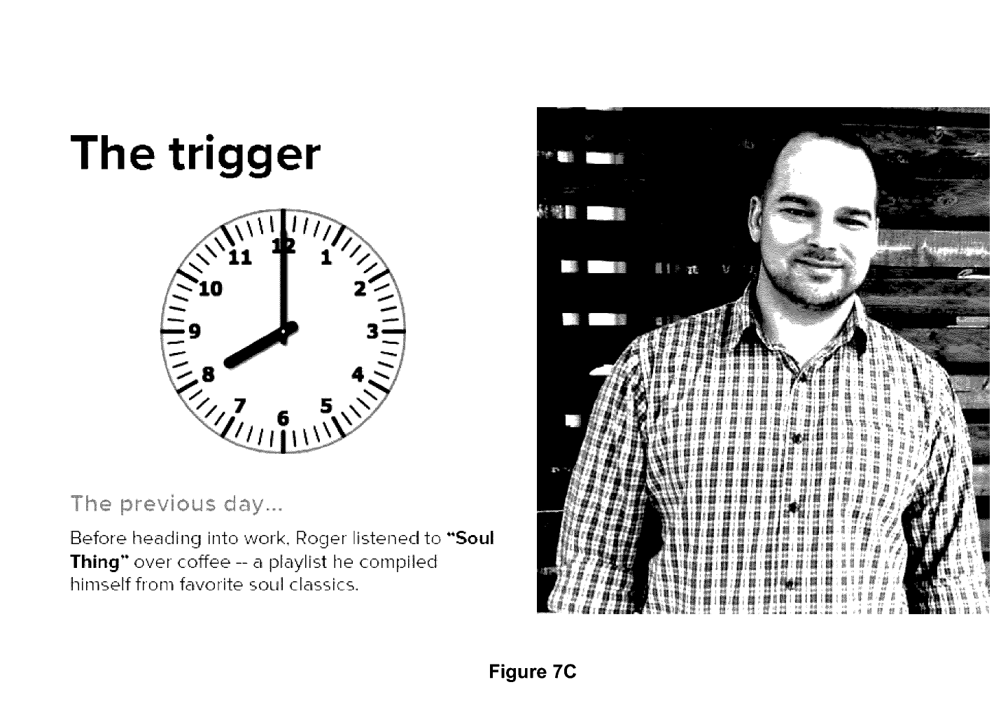

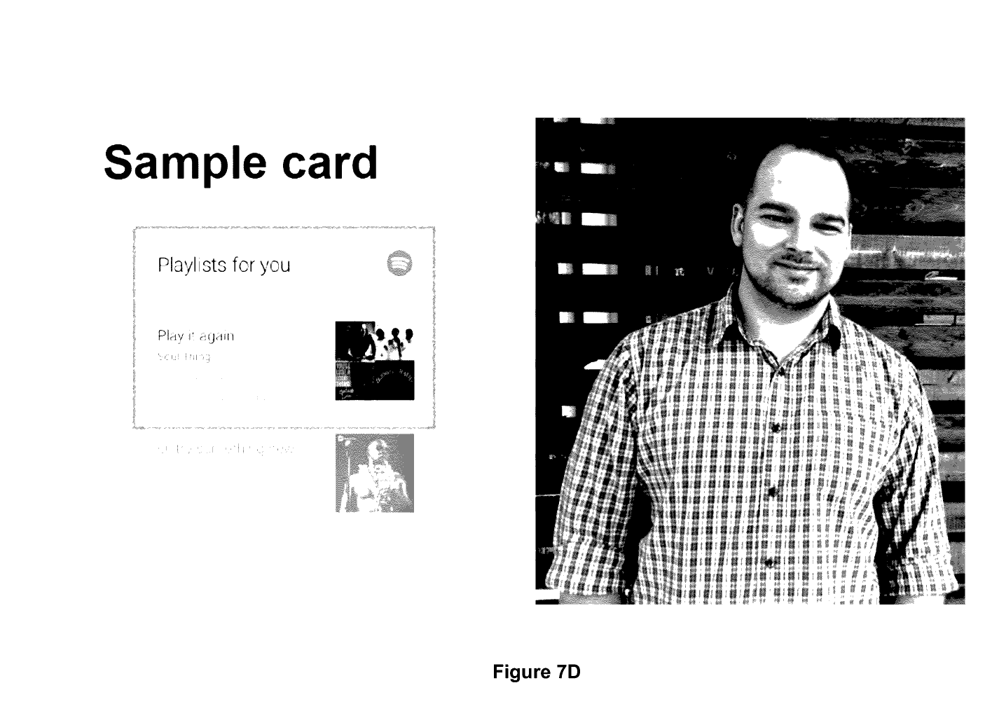

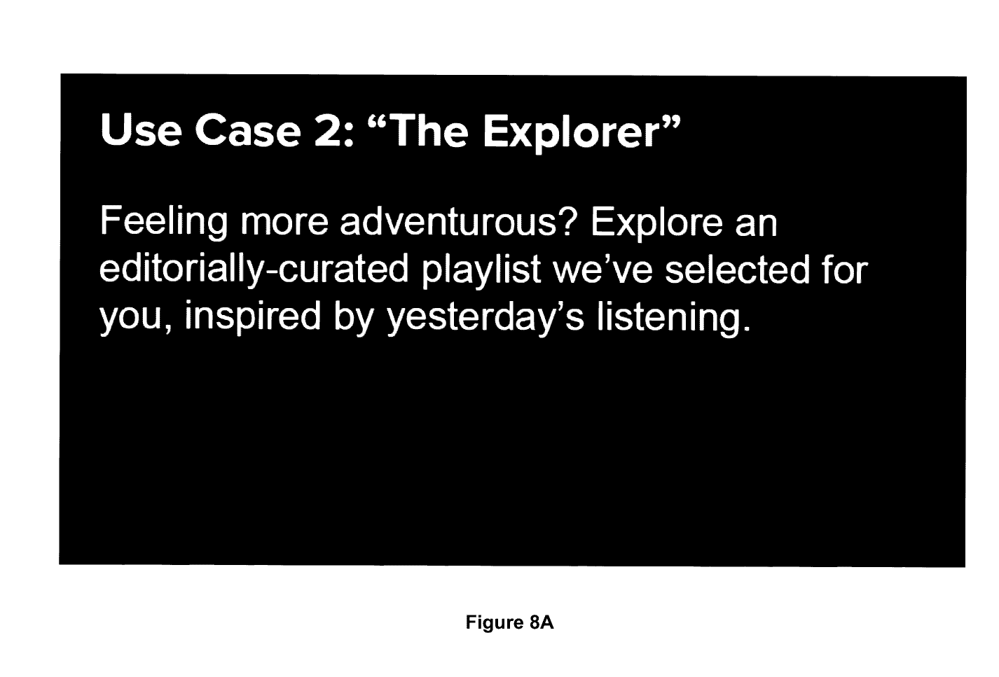

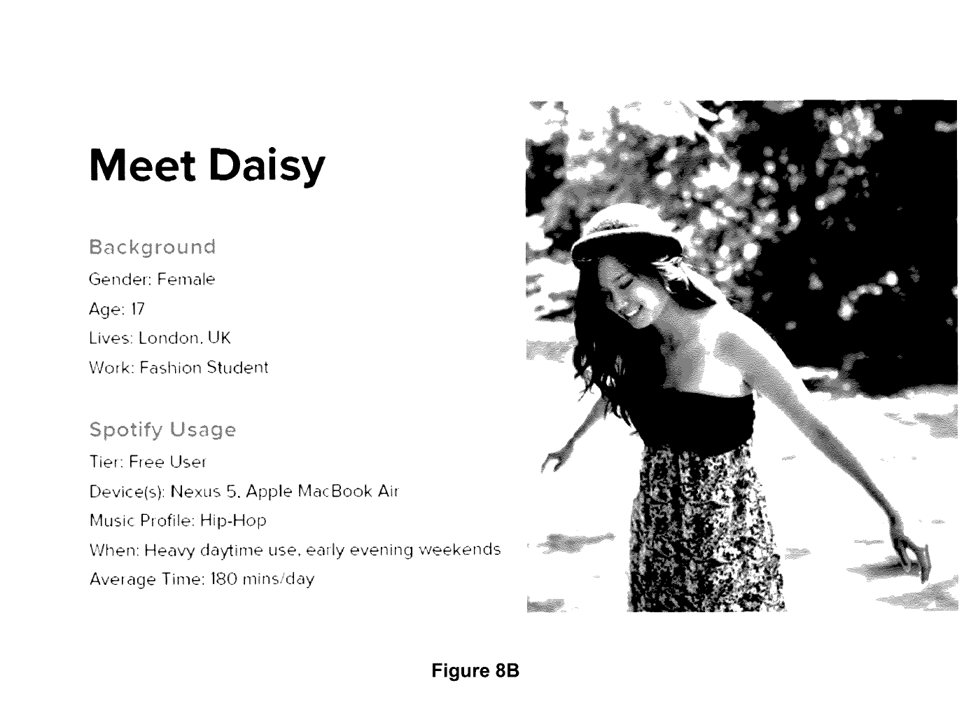

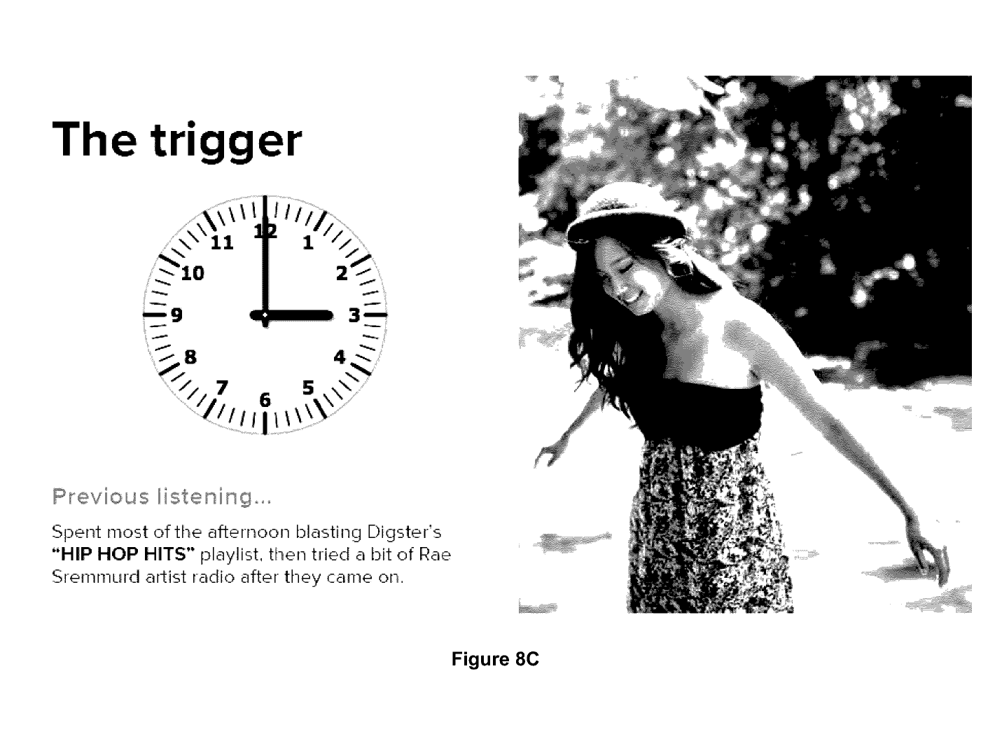

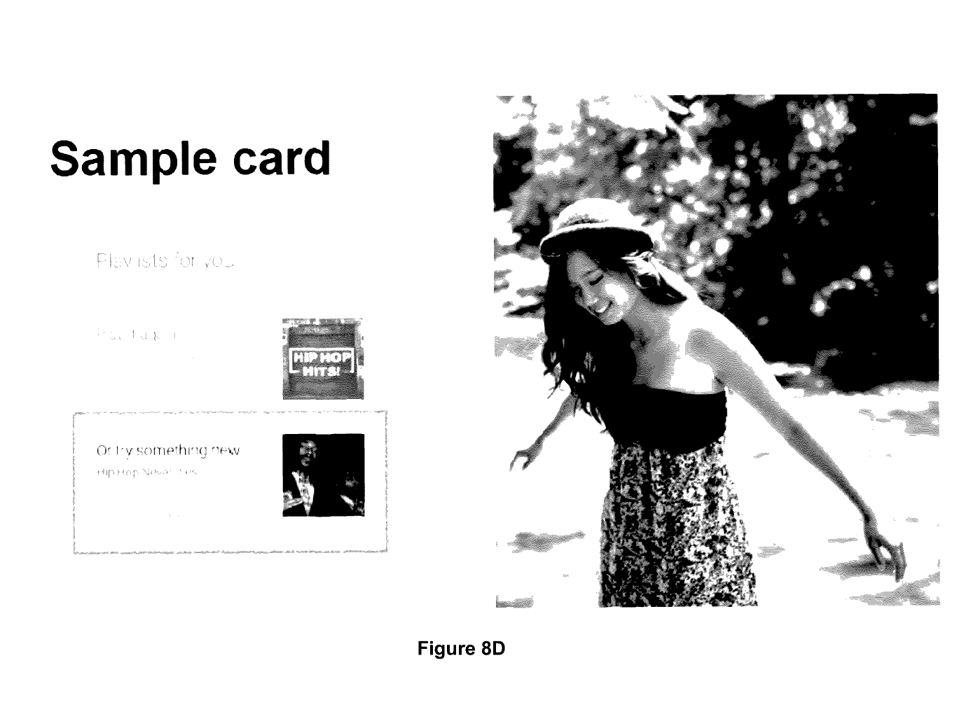

FIGS. 7 and 8, respectively disclose to exemplary use case scenarios where embodiments described herein may be applicable, or useful. FIGS. 7A-7D illustrate a first use case scenario where a user can be presented with a playlist proposal, which is a playlist of previously media that was played by the user at a same or similar time of a prior day. FIGS. 8A-8D illustrate a second use case scenario where a user can be presented with a playlist proposal, which is automatically generated by computer server system 300 based on previously played media. As can be seen in FIG. 7D and FIG. 8D, respectively, different cards can be displayed at the UI 230 of the electronic device 200, where a first card presents a media playlist in accordance with the first use case scenario and a second card presents a media playlist in accordance with the second use case scenario. As will be appreciated, the various embodiments described herein may allow for more personalized playback of media in that the media playlists are proposed on the basis of previously played media.

Also, some embodiments allow for time-aware proposals of the playlists to be suggested to the electronic device. For example, certain media playlists are proposed in morning time, whereas other media playlists are proposed at noon, in the afternoon, in the evening and at night.

Also, some embodiments allow for location-aware proposals of the playlists to be suggested to the electronic device. For example, certain media playlists are proposed when the user (or rather the electronic device brought by the user) is located in cities, whereas other media playlists are proposed when the user is located in the country, or is travelling (e.g., by car or train), etc.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the described embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks, may be provided through the use of hardware such as circuit hardware and/or hardware capable of executing software in the form of coded instructions stored on the above-mentioned computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC(s)), and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended list of selected example embodiments. As used herein, the terms “comprise/comprises” or “include/includes” do not exclude the presence of other elements or steps. Furthermore, although individual features may be included in different embodiments, these may possibly advantageously be combined, and the inclusion of different numbered embodiments does not imply that a combination of features is not feasible and/or advantageous. In addition, singular references do not exclude a plurality.

What is claimed is:

1. A system for playback of streamed media content, comprising:
an electronic device including a first processing circuit, a first communication circuit, a first memory, and a user interface; and
a computer system including a second processing circuit, a second communication circuit, and a second memory storing at least one data message that is to be operated on, each of which includes (a) a subscriber identity parameter associated with said electronic device, and (b) information related to previously played media content associated with the subscriber identity parameter; wherein
the computer system is configured to:
retrieve the stored at least one data message from the second memory to determine (a) the subscriber identity parameter associated with said electronic device, and (b) the information related to previously played media content associated with the subscriber identity parameter,
create at least one proposed media playlist based on (a) the subscriber identity parameter associated with said electronic device as well as the (b) information related to previously played media associated with the subscriber identity parameter,
generate a media data message including said at least one proposed media playlist, and
communicate a signal including said media data message to the electronic device; and
wherein the electronic device is configured to:
receive said media data message including said at least one proposed media playlist; in response thereto
generate a visual array of at least one media option corresponding to said at least one proposed media playlist; and
provide said visual array of the at least one media option at the user interface.

2. The system of claim 1, wherein the electronic device is further configured to arrange the at least one media option in a two-dimensional grid or list and to provide the at least one media option in said two-dimensional grid or list.

3. The system of claim 2, wherein the electronic device is further configured to provide each one of the at least one media option in the form of a card, the card including metadata related to the media option.

4. A method of generating visual media playlists at a user interface of an electronic device, the method being performed by a computer server system including a processing circuit, a communication circuit, and a memory storing at least one data message that is to be operated on, each of which includes: (a) a subscriber identity parameter associated with said electronic device, and (b) information related to previously played media content associated with the subscriber identity parameter, the method comprising:
retrieving, by the processing circuit, the stored at least one data message from the memory to determine (a) the subscriber identity parameter associated with said electronic device, and (b) the information related to previously played media content associated with the subscriber identity parameter;
creating, by the processing circuit, at least one proposed media playlist based on (a) the subscriber identity parameter associated with said electronic device as well as the (b) information related to previously played media content associated with the subscriber identity parameter;
generating, by the processing circuit, a media data message including said at least one proposed media playlist; and
communicating, by the communication circuit, a signal including said media data message to the electronic device.

5. The method of claim 4, comprising:
collecting, by the processing circuit, the information related to previously played media content associated with the subscriber identity parameter during a predefined period of time; and
storing, in the memory, said information related to previously played media content associated with the subscriber identity parameter.

6. The method of claim 5, wherein the predefined period of time is at least one of (1) a prior day or a portion thereof and (2) a corresponding period of time of a prior day.

7. The method of claim 6, wherein the predefined period of time includes the last 24 hours.

8. The method of claim 4, further comprising:
receiving, by the communication circuit, a signal from the electronic device, the signal comprising a data message including information about a current position of the electronic device; and wherein
creating, by the processing circuit, said at least one proposed media playlist is further based on the current position of the electronic device.

9. The method of claim 4, comprising:
establishing, by the processing circuit, a time of a day; and wherein
creating, by the processing circuit, said at least one proposed media playlist is further based on the time of the day.

10. The method of claim 9, wherein establishing the time of a day comprises:
receiving, by the communication circuit, a signal from the electronic device, the signal comprising a data message including information about a time zone location of the electronic device; and wherein
the time of a day is based on the information about the time zone location.

11. A method performed by an electronic device for generating visual media playlists at a user interface of the electronic device, the electronic device including a processing circuit, a communication circuit, and memory, and the method comprising:
receiving, by the communication circuit, a media data message including at least one proposed media playlist, wherein the at least proposed media playlist is based on (a) a subscriber identity parameter associated with the electronic device and the (b) information related to previously played media associated with the subscriber identity parameter; in response thereto
generating, by the processing circuit, a visual array of at least one media option corresponding to said at least one proposed media playlist; and
providing, by the processing circuit, said visual array of the at least one media option at the user interface of the electronic device.

12. The method of claim 11, wherein:
generating the visual array of the at least one media option comprises arranging the at least one media option in a two-dimensional grid or list; and
providing said visual array of the at least one media option at the user interface comprises providing the at least one media option in said two-dimensional grid or list.

13. The method of claim 11, further comprising:
providing each one of the at least one media option in the form of a card, the card including metadata related to the media option.

14. An electronic device, comprising:
one or more processors; and
memory storing one or more programs for execution by the one or more processors, the one or more programs including instructions for performing the method according to claim 4 or 11.

15. A non-transitory computer readable storage medium storing one or more programs, the one or more programs comprising instructions, which, when executed by an electronic device with one or more processors, cause the electronic device to perform the method according to claim 4 or 11.
